(19) United States
(12) Patent Application Publication
(10) Pub. No.: US 2008/0084972 A1
(43) Pub. Date: Apr. 10, 2008

(54) Verifying that a message was authored by a user by utilizing a user profile generated for the user

(76) Inventors: Michael Robert Burke, Rochester, MN (US); Zachary Adam Garbow, Rochester, MN (US); Kevin Glynn Paterson, San Antonio, TX (US)

Correspondence Address: WOOD, HERRON & EVANS, L.L.P. (IBM), 2700 CAREW TOWER, 441 VINE STREET, CINCINNATI, OH, 45202, US

(21) Appl. No.: 11/535,587

(22) Filed: Sep. 27, 2006

(51) Int. Cl. H04M 1/64

(52) U.S. Cl. 379/88.02

(57) ABSTRACT

An apparatus, program product and method that generate a user profile and verify the authorship of a second message against the user profile. As such, messages inconsistent with the user profile, which may be indicative of authorship by another user, may be detected primarily from one side of a communication, generally resulting in safer instant messaging and/or emailing. Additionally, reauthentication and/or blocking capabilities may be utilized to handle messages inconsistent with the user profile.

### FIELD OF INVENTION

The invention relates to computers and computer systems, and in particular, to authentication of user identities.

### BACKGROUND OF THE INVENTION

The Internet has profoundly changed many aspects of contemporary society, and has become an increasingly important resource for numerous educational, entertainment and commercial purposes. In particular, the Internet facilitates information exchange between users, and as such, instant messaging and emailing have become popular forms of communication, both for personal and business use.

Instant messaging systems typically permit users, whom are logged onto the same instant messaging system, to send and receive instant messages or communications to and from each other in realtime. An instant messaging system generally handles the exchange of instant messages, and typically supports the ability to display an instant messaging window incorporating a running transcript of the ongoing chat between the participating users on each user's computer screen. Instant messaging systems are implemented via a client-server environment or a peer to peer environment.

Email systems, on the other hand, permit a user to leave a message for another user who may not be logged onto the email system at the same time. The other user may then view the email once he or she logs into the email system at a later time. Email systems are generally implemented via a client-server environment.

To gain access to an instant messaging and/or email system, a user is generally required to login into his or her account. In particular, a user typically inputs a username and password combination, which is typically selected when the user registers for the account. Although the username and password combination may provide some level of security that the user logging onto the instant messaging and/or email system is the user listed on the account, and that the user communicating from the account is the user listed on the account, such may not always be the case.

As an example, malicious users may purposefully gain access to an instant messaging and/or email account with an automatic login feature, or potentially by surreptitiously discovering a user's username and password. As another example, multiple users (e.g., helpdesk personnel or family members) may purposefully login into and communicate via a single instant messaging account and/or email account. Furthermore, some users enable the automatic login features of their accounts, which eliminate the need to manually enter the username and password combination on their personal system. As such, when multiple users utilize the same computer, another user on the computer may accidentally login into and communicate via an instant messaging account and/or email account (e.g., a child may accidentally access an account of a parent with an enabled automatic login feature) without having to input the username and password combination.

As a result, although a user may think that the incoming instant messages and/or emails received from another user's account were written by the other user, instead, the communications may be coming from someone entirely different. Thus, an unauthorized user impersonating the other user may learn confidential information, learn age inappropriate information, utilize the username and/or email address to attack other systems and/or users, etc. Moreover, the other user may not even know that his or her system is being used surreptitiously by another, so from that other user's perspective the user's outgoing instant messages and/or emails may be suspect to him or her as well.

Although some technology, such as biometric and keyboard recognition (e.g. typing speed or typing pressure), may be utilized to provide security for instant messaging and/or email systems, these technologies are generally expensive to implement and as such, are not widely implemented. Moreover, wide implementation on different devices (e.g., cell phone, PDA, laptop, etc.) may be necessary to ensure security. Furthermore, these technologies suffer from the fundamental limitation that they ensure the authenticity only of the particular user that interacts with these technologies. The technologies do nothing to ensure the authenticity of other individuals with whom a user may be communicating.

A need therefore exists for an improved manner of verifying the identity of the author of a message, and in particular an approach that can be primarily implemented from a user's system without having to rely on the security of another user's system.

### SUMMARY OF THE INVENTION

The invention addresses these and other problems associated with the prior art by providing an apparatus, program product, and method that generate a user profile and verify the authorship of a message against the user profile. In particular, embodiments consistent with the invention may generate a user profile for a user by analyzing at least one message authored by the user, and verify that another message was authored by the user by utilizing the user profile to determine a consistency measure between the other message and the user profile.

By doing so, messages inconsistent with the user profile, which may be indicative of authorship by another user, may be detected primarily from one side of a communication, generally resulting in safer instant messaging and/or emailing. As such, the user profile may be generated primarily on one side of a conversation to verify the authorship of a message to be sent and/or received. Furthermore, in some embodiments the authorship of messages may be continuously verified against the user profile for a change of authorship beyond the initial authentication.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a client-server computer system implementing user profile-based authentication consistent with the invention.

FIG. 2 is a block diagram of a peer to peer computer system implementing user profile-based authentication consistent with the invention.

FIG. 3 is a user profile generation routine capable of being executed by the system of FIG. 1 or 2.

FIG. 4 is a outgoing message verification routine capable of being executed by the system of FIG. 1 or 2.

FIG. 5 is an incoming message verification routine capable of being executed by the system of FIG. 1 or 2.

### DETAILED DESCRIPTION

The embodiments discussed hereinafter generate a user profile and verify the authorship of a message against the user profile. A user profile consistent with the invention may be practically any aggregation of historical information about a user or associated with a user. For instance, the user profile may contain information as to prior keyword usage, text formatting usage, emoticon usage, cursing frequency, user-specific information usage, punctuation usage, error usage, capitalization usage, average sentence length, language usage, timing, etc. A user profile may include information not consciously provided by a user, e.g., information other than an account, address or password. A user profile for a user may be updated periodically or continuously based on the analysis of additional messages authored by the user.

Those of ordinary skill in the art will appreciate that the verification of message authorship may be used for messages that are incoming or outgoing. Thus, in some embodiments, a user profile may be generated for a user to verify the authorship of his or her outgoing messages and/or a user profile may be generated for a user to verify the authorship of incoming messages purportedly received from that user. As an example, a user profile may be generated locally for a local user and may be utilized to verify outgoing messages from the local user to protect from an unauthorized entity sending outgoing messages from the local user's system. Moreover, a user profile for a remote user may be generated on the local user's side to verify incoming messages from the remote user. As such, the local user may not have to rely on the security of the remote user's system for incoming messages. Although the wording “local user” and “remote user” will be utilized herein for simplicity, those of ordinary skill in the art will appreciate that the use of “local” and “remote” is not meant to limit the scope of the present invention.

Additionally, a user profile may be persistent, and in some embodiments, a user profile may be shared. For instance, a local user may be able to share his or her user profile with a remote user. As such, a user profile that may be generated on the remote user's side may be based upon the shared user profile, and the generated user profile may be updated with analysis from the messages received from the local user. When a user profile is shared, the user profile may be encrypted and/or signed to protect the user profile from becoming compromised. Similarly, the remote user may share the user profile generated on the remote user's side with the local user or with another user, and it may be desirable to provide a centralized service that can be remotely accessed by any authorized users as needed. Additionally, in some embodiments, separate user profiles may be generated, for example, for personal emails, business related emails, personal instant messages, business related instant messages, etc. Some user profiles may be combined and utilized in combination.

Consistent with the invention, a “message” may be practically any communication or portion of any communication that is outgoing (e.g., sent and/or capable of being sent) and/or incoming (e.g., received and/or capable of being received) via a computer system (e.g., an instant messaging system, an email system, Voice Over Internet Protocol (VoIP) system, online gaming system, etc.). For instance, a message may be at least a portion of an instant message, at least a portion of an email, at least a portion of a VoIP message, etc. Those of ordinary skill in the art may appreciate from the discussion hereinbelow that a message may also refer to one or more messages.

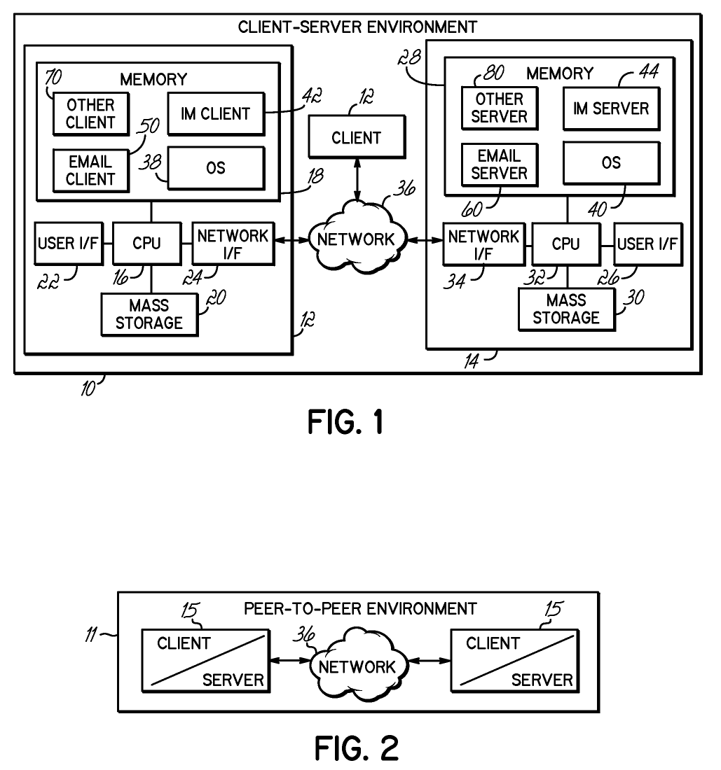

Turning now to the Drawings, wherein like numbers denote like parts throughout the several views, FIG. 1 illustrates a client-server based computer system or environment 10 consistent with the invention. In particular, the client-server computer system 10 may be part of an instant messaging system with the client computers 12 as instant messaging clients and the server computer 14 as an instant messaging server coupled to one another over a network 36. On the other hand, the client-server computer system 10 may be part of an email system with the client computers 12 as email clients and the server computer 14 as an email server. Similarly, the client-server computer system 10 may be part of another system with the client computer 12, for example, as a VoIP client, online gaming client, etc.

FIG. 2 generally illustrates a peer to peer based computer system or environment 11 that may also be used consistent with the invention and as an alternative to client-server system 10. In particular, the peer to peer computer system 11 may be part of an instant messaging system, email system, VoIP system, online gaming system or other system with one or more peer computers 15 interfacing with one another via a network 36. Each peer computer 15 may act as both a client 12 and a server 14 as generally described by like numbers in connection with FIG. 1. Peer to peer computer architectures are known to those of ordinary skill in the art and practically any peer to peer computer system may be used consistent with the invention.

Returning to FIG. 1, system 10 includes at least one apparatus, e.g., one or more client computers 12 and one or more server computers 14. For the purposes of the invention, each computer 12, 14 may represent practically any type of computer, computer system, or other suitable programmable electronic device consistent with the invention. Moreover, each computer 12, 14 may be implemented using one or more networked computers, e.g., in a cluster or other distributed computing system. Moreover, as is common in many client-server systems, typically multiple client computers 12 will be interfaced with a given server computer 14.

Computer 12 typically includes a central processing unit 16 including at least one microprocessor coupled to memory 18, which may represent the random access memory (RAM) devices comprising the main storage of computer 12, as well as any supplemental levels of memory, e.g., cache memories, non-volatile or backup memories (e.g., programmable or flash memories), read-only memories, etc. In addition, memory 18 may be considered to include memory storage physically located elsewhere in computer 12, e.g., any cache memory in a processor in CPU 16, as well as any storage capacity used as a virtual memory, e.g., as stored on a mass storage device 20 or on another computer coupled to computer 12. Computer 12 also typically receives a number of inputs and outputs for communicating information externally. For interface with a user or operator, computer 12 typically includes a user interface 22 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 12 may also include one or more mass storage devices 20, e.g., a floppy or other removable disk drive, a hard disk drive, a direct access storage device (DASD), an optical drive (e.g., a CD drive, a DVD drive, etc.), and/or a tape drive, among others. Furthermore, computer 12 may include an interface 24 with one or more networks (e.g., a LAN, a WAN, a wireless network, and/or the Internet, among others) to permit the communication of information with other computers and electronic devices. It should be appreciated that computer 12 typically includes suitable analog and/or digital interfaces between CPU 16 and each of components 18, 20, 22 and 24 as is well known in the art.

In a similar manner to computer 12, computer 14 includes a CPU 32, memory 28, mass storage 30, user interface 26 and network interface 34. However, given the nature of computers 12 and 14 as client and server, in many instances computer 14 will be implemented using a multi-user computer such as a server computer, a midrange computer, a mainframe, etc., while computer 12 will be implemented using a desktop or other single-user computer. As a result, the specifications of the CPU's, memories, mass storage, user interfaces and network interfaces will typically vary between computers 12 and 14. Other hardware environments are contemplated within the context of the invention.

Computers 12, 14 are generally interfaced with one another via a network 36, which may be public and/or private, wired and/or wireless, local and/or wide-area, etc. Moreover, network 36 may represent multiple, interconnected networks. In the illustrated embodiment, for example, network 36 may include the Internet.

Each computer 12, 14 operates under the control of an operating system 38, 40, and executes or otherwise relies upon various computer software applications, components, programs, objects, modules, data structures, etc. (e.g. instant messaging (IM) client 42 and instant messaging (IM) server 44, email client 50 and email server 60, or another client 70 such as but not limited to a VoIP or online gaming client and other server 80 such as a VoIP or online gaming server). Moreover, various applications, components, programs, objects, modules, etc. may also execute on one or more processors in another computer coupled to computer 12, 14 via a network, e.g., in a distributed or client-server computing environment, whereby the processing required to implement the functions of a computer program may be allocated to multiple computers over a network. Additionally, computer 12 and/or 14 may also have a database which may be resident, for example, in mass storage 20, 30 or in memory 18, 28, that may be accessed by a database management system (DBMS) which may be resident in memory 18, 28.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to tangible recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

As noted above, embodiments consistent with the invention are generally configured to generate a user profile and verify the authorship of a message against the user profile. An instant messaging (IM) client 42, email client 50, or other client 70 may generate a user profile for a user by analyzing at least one message presumably authored by the user and the instant messaging (IM) client 42, the email client 50, or the other client 70 may verify that another message was authored by the user by utilizing the user profile of the user to determine a consistency measure between the other message and the user profile. In particular, the user profile is either for a local user of the system or for a remote user with which the local user interacts. Via the user profiles, the authorship of messages may be verified and a local user may be protected from an unauthorized entity sending outgoing messages from the local user's system and/or the local user may not have to rely on the security of the remote user's system for incoming messages.

Those of ordinary skill in the art will appreciate that in instances where multiple users utilize a system, each local user may have at least one user profile generated for him or her by a client. Similarly, at least one user profile may be generated by a client for each remote user with which the local user interacts. Additionally, a user profile may be generated on a system for a local user only, a remote user only, or both a local and a remote user consistent with the principles of the present invention. The number of user profiles generated may depend upon the capability of the system. Moreover, in some embodiments, the user profile may be generated by a server or by another application or tool on a client. A generated user profile may also be shared via a network and at least a portion of the shared user profile may be utilized by a client to generate a user profile.

Those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

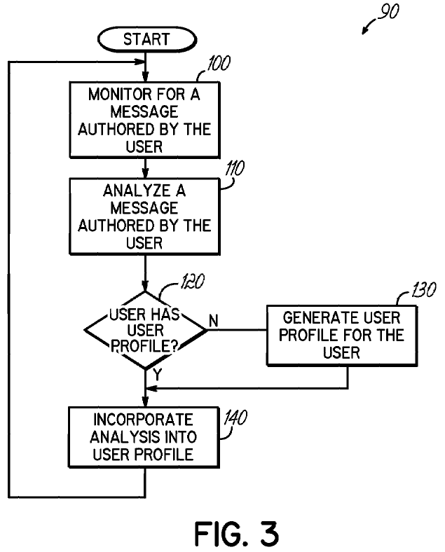

Turning now to FIG. 3-5, these figures illustrate routines that may be executed, for example, by a client in a computer system as described above. Starting with FIG. 3, FIG. 3 illustrates an exemplary routine 90 for generating a user profile consistent with the principles of the present invention. Turning to block 100, block 100 monitors for a message authored by the user. The message may be an instant message or an email message, or practically any other type of message that may be authored by a user. One of ordinary skill in the art may appreciate that if a message is not authored by the user, the user profile that may be generated may be at least partially inaccurate. However, such inaccuracies may be reduced over time as the user profile is updated (e.g., via additional communication and additional data).

Next, block 110 analyzes the message authored by the user (e.g., local user or remote user). The message is analyzed for any number of characteristics indicative of a particular user's writing style, e.g., keyword usage (e.g., abbreviations such as LOL, brb, ILC, etc., words associated with the user or the field of occupation of the user such as Java programmer, names of Java methods, names of Java classes, etc.), text formatting usage (e.g., right indent between 75-80 characters, etc.), emoticon usage (e.g., happy faces at the end of each sentence, no happy faces, etc.), cursing frequency (e.g., never curses, how many curse words are utilized, always curses, etc.), user-specific information usage (e.g., related contacts such as the name of a daughter, son, etc., proper names, the specific curse words utilized, etc.), punctuation usage (e.g., does the user utilize periods and other punctuation, etc.), error usage (e.g., misspells certain words, grammatical mistakes, etc.), capitalization usage (e.g., capitalize all words, capitalize only the first letter, etc.), average sentence length (e.g., one or two word messages, short messages, long messages, how many words in each sentence, etc.), language usage (e.g., which language or languages was the message written in), etc. Additionally, the message may be analyzed for other characteristics such as timing, for instance, the time of day or night associated with the message, the amount of time in between messages (e.g., 30 seconds, 1 minute, 5 minutes etc.), etc.

Next, block 120 determines whether the user has a user profile. If the user does not, then block 130 generates the user profile for the user. However, if the user already has a user profile, the analysis of the message may be incorporated into that preexisting user profile in block 140. As such, the user profile may be updated with information from messages authored by the user. Next, control passes to block 100 to continue monitoring for messages authored by the user.

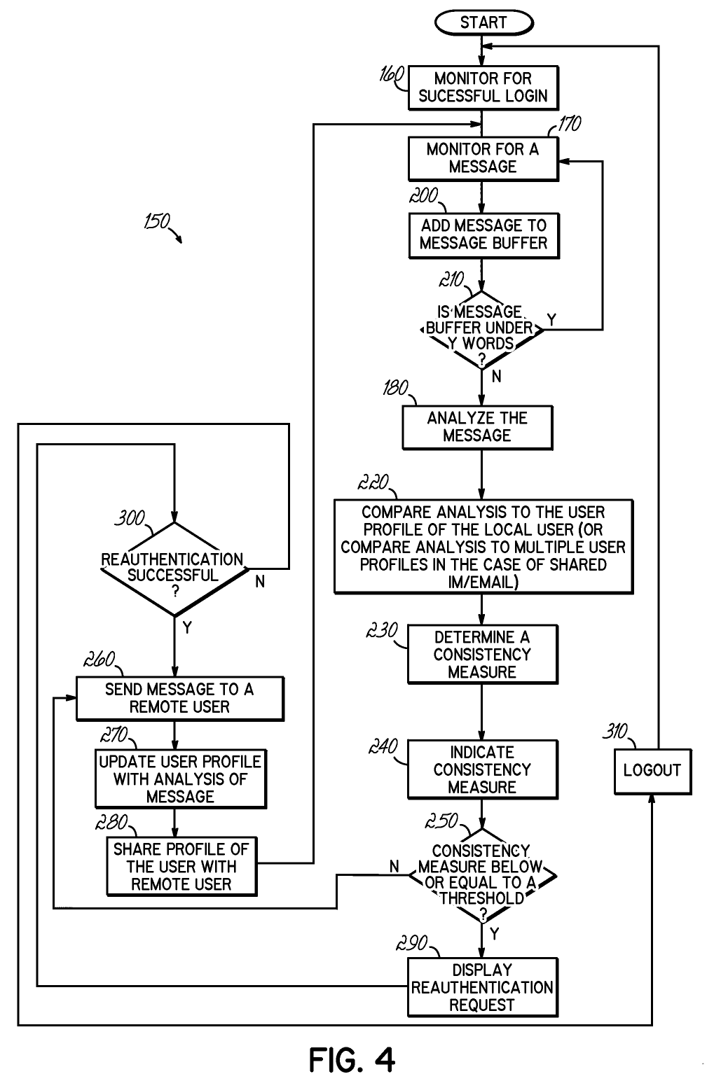

Turning now to FIG. 4, FIG. 4 illustrates an exemplary routine 150 suitable for verifying the authorship of an outgoing message consistent with the principles of the present invention, which may be utilized prior to sending a message to detect whether the message that has been authored in a local computer is likely to have emanated from its purported author. Turning to block 160, block 160 monitors for a successful login. This successful login may be a manual login where a user inputs a username and password or may be accomplished by enabling an automatic login feature of an instant message account, an email account, etc. Once a successful login is detected, block 170 monitors for messages being sent by that user. As used herein, a message is a message that may or may not have been written by the user, and as such, the authorship of the message will be verified by utilizing the user profile of the user. The message of block 170 may be a message that is written in a text box and it has not yet been sent to another (e.g., a remote user).

Next, block 200 adds the message to a message buffer. Those of ordinary skill in the art may appreciate that, for example, sometimes instant messages and/or emails are short and may even be messages containing a single word. As such, the analysis of a single word may not be as meaningful as the analysis of multiple words; thus, it may be preferable to store the shorter messages in a message buffer until the message buffer is sufficiently large (e.g., meeting or exceeding a threshold) for conducting the analysis. However, the message may be immediately large enough for meaningful analysis. As illustrated in FIG. 4, the message is added to a message buffer in block 200 and block 210 determines whether the message buffer is under Y number of words. In some embodiments, Y is configurable. If the message buffer is under Y words, then control passes to block 170 to monitor for another message. Control may continue to pass from block 170, 200 and 210 until the message buffer contains enough words equal to or above Y number of words. Once the message buffer is not under Y words, control may pass to block 180 to analyze the messages from the message buffer.

In some embodiments, instead of adding the message to the message buffer in block 200, the length of the message may first be determined. If the length of the message is not sufficiently large as compared to a threshold X, which may also be configurable, then the message may be added to the message buffer. However, if the length of the message is sufficiently large, the message may be analyzed directly without adding the message to a message buffer. The routine 150 of FIG. 4 may be adapted for this implementation.

Next, in block 220, the analysis of the message from block 180 may be compared with the user profile of the local user. Specifically, the message may be analyzed for a departure from the user's writing style. For instance, if the local user always includes the name of his daughter in his or her messages and the name of the daughter is not included in the message or mentions a different name then this may be indicative that the message was written by another. Similarly, the following examples may indicate a departure from the user's writing style: a user that always curses stops cursing, a user that references keywords does not reference any keywords, a user spells correctly a word that he or she always misspells, a user utilizes punctuation resulting in shorter sentences when he or she does not utilize punctuation and therefore has longer sentences, etc. In some embodiments, the analysis may be compared to multiple user profiles. For instance, when multiple individuals share a single account (e.g., instant message account and/or email account), the message may have been written by any one of the individuals. As such, the message may be compared to multiple user profiles.

Block 230 determines a consistency measure that may be optionally indicated (e.g., by displaying on a display) in block 240. A consistency measure consistent with the principles of the present invention may be practically any value that may be used to indicate consistency between the message and the user profile. For instance, a consistency measure may be a confidence level. On the other hand, a consistency measure may also be a true or false value. As an example, if an individual never uses curse words in the instant messages that he or she writes as determined by their user profile and an analysis of a message presumably from the individual has curse words, then a value of false instead of a confidence level may be used. On the other hand, a confidence level may be used when the analysis does not lend itself to a true or false (binary) conclusion.

Next, block 250 may determine whether the consistency measure (e.g., a confidence level) is below or equal to a threshold. The threshold may be configurable by the user. If it is above a threshold, then this may indicate that the message was authored by the user as determined by the user profile of the user and the message may be sent to a remote user in block 260. The user profile of the local user may even be updated with the analysis of this message in block 270, thus, the user profile may be updated in realtime. Additionally, in some embodiments, the local user may share his or her profile with another user (e.g., a remote user) in block 280, and control may pass to block 170 to continue to monitor for other messages. As such, the shared user profile may be incorporated into the user profile of the local user that the remote user may be generating on the remote user's side, especially if the remote user and the local user have not had much contact prior to this communication exchange. However, as the user profile of the local user being created on the remote user's side gets updated, the weight of the shared user profile in the user profile generated by the remote user may be diminished.

Returning to block 250, if the consistency measure is below or equal to a threshold, then this may indicate that the message is inconsistent with the user profile, or with any user profile if multiple user profiles were compared in block 220, and an unauthorized entity (e.g., an individual, a virus, etc.) may be the author of the message. As such, control passes to block 290 to display a reauthentication request.

A reauthentication request may ask that the local user input his or her name and password or answer some other question. A request for reauthentication may pose a question to the writer of the message with an answer that the local user and not an entity impersonating the local user would know. Such a question may be what is the name of my pet, what is my middle name, who is my supervisor, etc. where my refers to the local user. Next, the task of requesting reauthentication may be performed. If the reauthentication is successful, then control may pass to block 260 to continue to send the message and to update the user profile in block 270, and possibly to share the user profile with another user in block 280. If the reauthentication is successful, the user profile may be updated in block 270 as the message may indicate that there is generally a difference with the user profile and updating the user profile may increase the likelihood that this difference will be incorporated into the user profile the next time the difference is encountered. However, if the reauthentication is not successful in block 300, then block 310 may logout or prohibit further access to the account, and pass control to block 160 to monitor for a successful login. It may also be desirable to notify the user of the discrepancy. If the reauthentication was unsuccessful, this may indicate that an unauthorized user authored the message.

As an example, a local user may allow his or her system, in particular, IM client 42, email client 50, or other client 70, to execute routines such as routine 90 of FIG. 3 to generate a user profile for the local user and routine 150 of FIG. 4 to verify outgoing messages. As such, a message written in that account may be analyzed and compared to the user profile of that local user (or compared to multiple profiles if there are multiple local users). When the consistency measure between a written message or multiple written messages stored in a message buffer is equal to or below a threshold, the writer may be asked to reauthenticate. Unsuccessful reauthentication may log a writer out of the account and may not send further messages to other users (e.g., remote users). As such, those of ordinary skill in the art may appreciate that routine 150 may be utilized to verify the authorship of messages even after the initial login and may reduce some of the dangers of accidental (e.g., child utilizing parents account) and/or malicious (e.g., hacker taking over an account) use of accounts, particularly those having enabled automatic login features. Additionally, routine 150 may not only provide some level of security on the local user's side, but it may protect the other users from receiving these messages (e.g., derogatory messages, spam, messages soliciting confidential information (e.g., data, links, etc.), or messages including attachments with viruses).

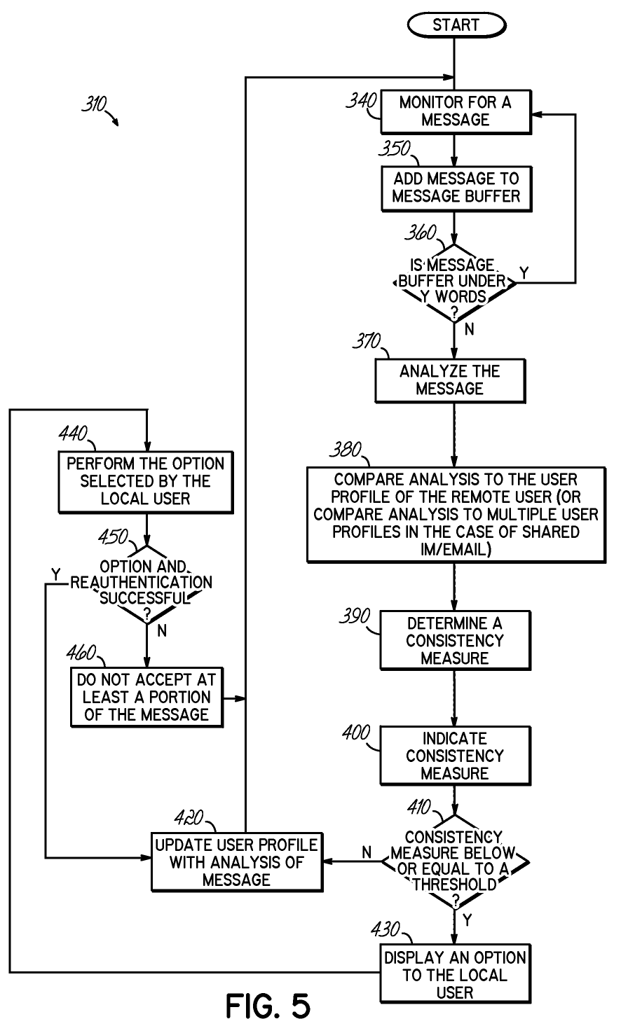

Turning next to FIG. 5, FIG. 5 illustrates an exemplary routine 310 suitable for verifying an incoming message consistent with the principles of the present invention. The description of blocks 170, 200, 210, 180, 220, 230, 240, and 250 in routine 150 in FIG. 4 is applicable to blocks 340, 350, 360, 370, 380, 390, 400 and 410. One of the differences between the two routines is that whereas in routine 150 the messages being monitored are outgoing messages, the messages referenced in block 340 of routine 310 are incoming messages. As blocks 340-410 are generally described hereinabove in connection with routine 150, the following discussion will focus on blocks 410 and onwards.

Turning to block 410, if the consistency measure between the message received by the local user as compared with the user profile or profiles that have been generated on the local user's side for a remote user, which may or may not contain at least a portion of a previously received profile shared from the remote user, is above a threshold, then control may pass to block 420 to update the user profile of the remote user with the analysis of the incoming message. As the message is consistent with the user profile of the remote user, the local user may feel more comfortable opening attachments or communicating more freely with the remote user. Control passes to block 340 to continue to monitor for a message received by the local user.

Returning to block 410, if the consistency measure is not above the threshold, and is therefore below or equal to the threshold, control passes to block 430 to generate an action event such as displaying at least one option to the local user which the local user may select and the option may be performed in block 440. The option that may be displayed may be, for example, an option to block the message, an option to block a portion of a message (e.g., an attachment), an option to warn (e.g., notify) against transmission of confidential information, an option to suppress transmission of confidential information, an option to request reauthentication of the sender (e.g., remote user), etc. The notification may also be just a warning that the message is suspect.

A request for reauthentication may refer to reauthenticating with a messaging system, or otherwise producing some direct assurance to the local user that the remote user was in fact the author of the incoming message. In particular, a request for reauthentication may pose a question to the sender of the message with an answer that the user and not an entity impersonating the user would know.

In some embodiments, the task may be preselected and stored as part of the local user's preferences. For instance, the local user may indicate in his or her preferences that he or she should always be warned against transmission of confidential information and that transmission of confidential information should be suppressed when the consistency measure is below or equal to a threshold. The local user may select one of the options and a task incorporating the selected option may be performed in block 440.

Next, block 450 determines whether the option and reauthentication were successful. Those of ordinary skill in the art may appreciate that it may be beneficial to request both reauthentication as well as another option such as to temporarily block receipt of at least a portion of the message. However, in some embodiments, block 450 may be changed or omitted, etc. If both were successful, then the user profile generated on the local user's side for the remote user may be updated with the analysis of the incoming message and the message may be treated as other messages conventionally received whose consistency measure is above the threshold. Next, control passes to block 340 to monitor for a message. But, if reauthentication failed, for example, control passes to block 460 where at least a portion of the message is not accepted and the user profile is not updated as it may still be undetermined whether an unauthorized user has sent the message. It may be possible that it is not an unauthorized user but the remote user has simply forgotten the answer to the question. Nonetheless, control passes to block 340 to continue to monitor for a message.

As an example, the local user may allow his or her system, in particular, IM client 42, email client 50, or other client 70, to execute routines such as routine 90 of FIG. 3 to generate a user profile for a remote user and routine 310 of FIG. 5 to verify incoming messages. Thus, an incoming message may be analyzed and the analysis may be compared to the user profile of the remote user (or multiple user profiles when multiple remote user profiles exist) generated on the local user's side. If a consistency measure for the message or messages received by the local user from the remote user are below or equal to a threshold, the local user may be warned and/or provided with other options such as an indication to request reauthentication. As such, the entities sending the message, which may be the remote user and not an unauthorized user impersonating the remote user may be blocked momentarily and may have to reauthenticate to continue. If reauthentication fails, at least a portion of the message may not be accepted by the local user. As such, the authorship of messages from a remote user may be verified past the initial login of the remote user, which may have been taken over by an unauthorized user, and may protect the local user from opening attachments with viruses, etc.

Those of ordinary skill in the art may appreciate that the embodiments discussed herein may reduce the need for trust in another user as user profiles may be created from either the local user's side, the remote user's side, or both sides and used to verify messages. As such, the authorship may be verified against a user profile via a consistency measure independent of the certificates or other security precautions another may or may not have implemented. The periodic or continuous update of a user profile may also increase the accuracy of the user profile as it may incorporate analysis from multiple interactions. Additionally, the user profile may be utilized in some embodiments to determine the true identity of an author of a message when multiple users use a single account by verifying the message against multiple user profiles. Furthermore, a user profile may not be limited to localized usage but may be shared or used in a more collaborative manner.

Various modifications may be made to the illustrated embodiments without departing from the spirit and scope of the invention. For instance, in some embodiments, the consistency measure may be a confidence level that represents a percentage and may start at 100%. This percentage may be adjusted as differences or discrepancies are detected between an incoming and/or outgoing message and a user profile, and are incorporated into the user profile. For instance, cursing frequency may rise to 400%. As such, the comparison in block 250 and/or 410 may vary in some embodiments. Therefore, the invention lies in the claims hereinafter appended.

What is claimed is:

1. A computer-implemented method of verifying the identity of an author of a message, the method comprising:
(a) generating a user profile for a user by analyzing at least one message authored by the user; and
(b) verifying that a second message was authored by the user by utilizing the user profile of the user to determine a consistency measure between the second message and the user profile of the user.

2. The computer-implemented method of claim 1, wherein verifying that the second message was authored by the user includes analyzing the second message.

3. The computer-implemented method of claim 2, further comprising incorporating at least a portion of the analysis of the second message into the user profile.

4. The computer-implemented method of claim 2, wherein analyzing the second message includes analyzing at least one of keyword usage, abbreviation usage, text formatting usage, emoticon usage, cursing frequency, user-specific information usage, punctuation usage, error usage, capitalization usage, average sentence length, language usage, or timing.

5. The computer-implemented method of claim 2, wherein analyzing the second message includes comparing the consistency measure to a threshold.

6. The computer-implemented method of claim 1, further comprising indicating the consistency measure.

7. The computer-implemented method of claim 1, further comprising in response to an inability to verify that the second message was authored by the user, displaying on a display at least one of an option to block the second message, an option to block a portion of the second message, an option to warn against transmission of confidential information, an option to suppress transmission of confidential information, an option to request reauthentication, or a reauthentication request.

8. The computer-implemented method of claim 1, further comprising in response to an inability to verify that the second message was authored by the user, performing a task selected from the group consisting of blocking the second message, blocking a portion of the second message, warning against transmission of confidential information, suppressing transmission of confidential information, requesting reauthentication, and any combination thereof.

9. The computer-implemented method of claim 1, further comprising updating the consistency measure in realtime.

10. The computer-implemented method of claim 1, wherein the consistency measure includes a confidence level.

11. The computer-implemented method of claim 1, wherein the second message is an outgoing message.

12. The computer-implemented method of claim 1, wherein the second message is an incoming message.

13. The computer-implemented method of claim 1, further comprising sharing the user profile with a second user.

14. An apparatus, comprising:
(a) a processor;
(b) a memory; and
(c) program code resident in the memory and configured to be executed by the processor to verify the identity of an author of a message by generating a user profile for a user based upon analysis of at least one message authored by the user, and verifying that a second message was authored by the user by utilizing the user profile of the user to determine a consistency measure between the second message and the user profile of the user.

15. The apparatus of claim 14, wherein the program code is further configured to verify that the second message was authored by the user by analyzing the second message.

16. The apparatus of claim 15, wherein the program code is further configured to incorporate at least a portion of the analysis of the second message into the user profile.

17. The apparatus of claim 15, wherein the program code is further configured to analyze the second message by analyzing at least one of keyword usage, abbreviation usage, text formatting usage, emoticon usage, cursing frequency, user-specific information usage, punctuation usage, error usage, capitalization usage, average sentence length, language usage, or timing.

18. The apparatus of claim 14, wherein the program code is further configured to respond to an inability to verify that the second message was authored by the user by displaying on a display at least one of an option to block the second message, an option to block a portion of the second message, an option to warn against transmission of confidential information, an option to suppress transmission of confidential information, an option to request reauthentication, or a reauthentication request.

19. The apparatus of claim 14, wherein the program code is further configured to respond to an inability to verify that the second message was authored by the user by performing a task selected from the group consisting of blocking the second message, blocking a portion of the second message, warning against transmission of confidential information, suppressing transmission of confidential information, requesting reauthentication, and any combination thereof.

20. The apparatus of claim 14, wherein the program code is further configured to update the consistency measure in realtime.

21. The apparatus of claim 14, wherein the consistency measure is a confidence level.

22. The apparatus of claim 14, wherein the second message is an outgoing message.

23. The apparatus of claim 14, wherein the second message is an incoming message.

24. The apparatus of claim 14, wherein the program code is further configured to share the user profile with a second user.

25. A program product, comprising:
(a) program code configured to verify the identity of an author of a message by generating a user profile for a user based upon analysis of at least one message authored by the user, and verifying that a second message was authored by the user by utilizing the user profile of the user to determine a consistency measure between the second message and the user profile of the user; and
(b) a computer readable medium bearing the program code.
